(19) United States
(12) Patent Application Publication
(10) Pub. No.: US 2009/0276721 A1
(43) Pub. Date: Nov. 5, 2009

(54) METHOD AND APPARATUS FOR CONFIGURING A DEVICE

(76) Inventor: Ian Bowman Brockbank, Edinburgh (GB)

Correspondence Address: DICKSTEIN SHAPIRO LLP, 1825 EYE STREET NW, Washington, DC, 20006-5403, US

(21) Appl. No.: 12/427,931

(22) Filed: Apr. 22, 2009

(30) Foreign Application Priority Data
Apr. 23, 2008 (GB) 0807428.8

(51) Int. Cl. G06F 3/048; G06F 15/177

(52) U.S. Cl. 715/764; 713/1

(57) ABSTRACT

To facilitate evaluation, testing and/or configuration of an electronic device, one or more interactive setting diagrams are provided in the form of a block diagram for showing inter-relationships of functional blocks of the device, and/or a diagram for showing signal processing functions of the device. In the case of an audio IC for example, respective block diagrams may be provided for audio routing, for clocking, for general purpose I/IO, and so on. Likewise, signal processing may be represented by diagrams for configuring filters and ALC. The diagrams are displayed on a display of a computer, having an input device which the user operates to change settings of the device. The user can interact directly with the interactive setting diagram by manipulating graphical controls incorporated into the diagram. Thus, for example, an audio path can be set by clicking on a signal line shown in the diagram, or filter settings modified by moving sliders displayed alongside a filter characteristic graph. Settings made in this way can be recorded for future re-use and/or reflected immediately in a register map of the device which may be connected to the computer via an evaluation board and interface.

### TECHNICAL FIELD

The present invention relates to a configuration method and apparatus, and in particular to an method and apparatus for configuring an electronic device. Here, “configuring” also refers to evaluating, testing or controlling the electronic device.

### BACKGROUND

Manufacturers of electronic devices often provide evaluation tools for use by their engineers and their customers. These tools enable engineers to set or change various settings of the electronic device, for example for testing or evaluation purposes during a system design. In this situation, the device is referred to as a Device Under Test (DUT). In addition to the ability to change various settings on the DUT, engineers may also need to retrieve and monitor the current settings.

There are a number of different scenarios where evaluation tools are used. FIG. 1A shows an example of a first scenario in which a DUT 1 is placed on an evaluation board 3 and controlled using a separate computer 5. The evaluation board 3 has appropriate supporting circuitry and components that allow the operation and performance of the DUT 1 to be evaluated. In this scenario, control software running on the computer 5 communicates with the DUT 1 via a communications link 7 (for example a USB, serial or parallel communications link). In practice some form of additional interface is also provided, for converting signals received from the computer 5 into signals that the DUT 1 can process. Typical communication interfaces for devices under test include AC'97, I²C, I²S or SPI. Such an arrangement is typically used during the initial evaluation of a DUT 1 (and also during development) to debug problems and work out how to achieve the best operation and performance from the DUT 1.

This is only one possible arrangement. Alternatively, for example, the DUT 1 is installed on some form of development platform that also includes all the processor(s), memory, controllers and other components and devices necessary to develop a full system. In this case the control software can be running on the development platform and communicating with the DUT directly via one or more interfaces, (for example AC'97, I²C, I²S or SPI as mentioned above). Alternatively or additionally, the control software can be running on a separate computer communicating with appropriate software on the hardware system across a communications link (for example network, serial or parallel link), said interface software communicating with the DUT directly as above. This type of arrangement is typically used during system development in order to help get a whole system up and running, including all of the hardware, software and drivers necessary for full development. The development platform is also used for debugging problems that occur when integrating the different components of the system. Once fully debugged and working, the development platform will typically be used as a reference platform for one or more customer applications (i.e. mass-market products).

In another possible arrangement, an electronic device is installed in an end system, in other words a hardware system that also includes all the processor(s), memory, controllers and other components necessary for a fully-functional apparatus. In this case the control software can be running on the hardware system and communicating with the device directly via one or more appropriate interfaces (for example AC'97, I²C, I²S or SPI as mentioned above). Alternatively or additionally, the control software can be running on a separate computer communicating with appropriate software on the hardware system across a communications link (for example network, serial or parallel link), said interface software communicating with the DUT directly as above. This scenario is typically used by a hardware manufacturer once a prototype system has been developed from a reference design, for debugging integration issues which occur during the development of the system.

As another possibility, the device need not even exist as a finished electronic device but might only exist in software. In this case it is possible to simulate the device as a program running on a computer and to “evaluate” the device by simulating the effect of various possible configurations, using other software running on the same or another computer.

In this specification, the terms “evaluation” and “configuration” are to be interpreted broadly to encompass all such kinds of testing, debugging and simulation.

The devices under test are controlled using registers which have an n-bit address (typically 6, 7, 8 or 16 bits) and an n-bit data value (typically 8, 9 or 16 bits). The data values consist of one or more data fields, each data field comprising one or more data bits for controlling various aspects of the device. The data values may also comprise one or more null bits which have no effect on the device.

When evaluating an electronic device in any of the above ways, engineers need to change the settings on the device. Currently the only way to do this is by interacting directly with each logical component within the device individually. This means that customers have to work out exactly which components they need to modify to achieve the desired effect. For example, when setting up a path on an audio device, the customer needs to ensure that every input, mixer, switch, multiplexer (mux) and output on the path is set correctly. For a complex device with many possible paths this can be non-obvious.

As an example of a device under test, FIG. 1B shows the block diagram from the datasheet of a recently-developed audio IC (the DUT 1), with the path for recording from a differential MIC on MIC2 highlighted. To set up this audio path requires the following register writes:
IFMODE to HiFi over HiFi Interface ‘10’
Set Left ADC Volume Update bit to ‘1’ & Volume Level to default
Power up VMID[50Kohm]; VREF & MICB
Power up ADCL, MICAMP2EN, ALCMIX & PGAL
Set MIC2ALC to MIC2 selected
Set Left input Volume Update bit to ‘1’ & Volume Level to default

FIG. 2 shows a screen display 10 from previously-proposed register control software. This is a generic tool which allows a register to be specified and then either written or read. It has a register index 13 and presents the value as both checkboxes 15 of individual bits and the complete value 17. It also has a history panel 19 showing what has been read and written. The history of operations can be useful for developing software. The register settings can be applied mechanically, or can be provided by support engineers in a form which can be loaded.

On the other hand, there is no indication of what register bits mean. Moreover, it is not easy to appreciate which registers need to be modified (or how) to set up the desired path. Setting up the above audio path will require all but the most experienced engineer to refer to the datasheet frequently.

Another problem is that it is difficult to tell exactly which blocks need to be powered up to set up the required path. It is easy to miss a required block, in which case the path will not work. Conversely, it is easy to leave unnecessary blocks powered up, using more power than required.

When evaluating or configuring audio devices with complex filters it can be difficult to visualise the effects of the filters and how they interact. For example, one recently-developed audio IC has a 5-band equaliser, high-pass filter and notch filter which can be applied either individually or in combination. Devices may also have automatic level control which will amplify or attenuate the signal to attempt to maintain a constant output signal level. These have various controls such as target signal level, maximum gain which can be applied and settings for how long the device takes to react to changes in level and how long it takes to apply the new settings when it detects a change (envelope control: hold, attack and decay times). Configuring these settings is frequently a matter of trial and error—making changes and listening to the result with test signals until the desired effect has been achieved.

FIGS. 3A to 3E are screen displays (20 to 24 respectively) from custom control software, provided to facilitate settings of the FIG. 1B audio IC. Screen display 20 (FIG. 3A) is for input selection and microphone bias. Screen display 21 is provided for power management (FIG. 3B). Further control panels handle interface control (22, FIG. 3C), audio mixing (23, FIG. 3D) and tone and ALC control (24, FIG. 3E). By providing customised control panels for each aspect of the IC's operation, each individual setting can be controlled in a reasonably intuitive manner, and the current settings can be ascertained without reference to the datasheet. On the other hand it is still difficult to get an overview of what is involved for the whole desired path or effect. For example, with reference to the FIG. 3E control panel for tone and ALC control, it is difficult to get a feel for exactly how this will affect the output waveform. As another example, referring to the audio path shown in FIG. 1B, unless the engineer is intimately familiar with the device, setting up this path will still require her to cross-reference the datasheet frequently, and there remains the above-mentioned problem of knowing which blocks to power up.

Another approach is to combine generic register control software with custom (i.e. device-specific) software as shown in FIG. 4. FIG. 4 shows a combined display 30 as might appear on a computer monitor, comprising a window 31 for a generic register control panel similar to that of FIG. 2, and 32 a window containing a custom panel for, in this example, controlling a graphic equaliser and filter. This allows each individual setting to be controlled in a reasonably intuitive manner (for example, the current settings can be ascertained without reference to the datasheet). There is also a history of operations which can be used for developing software. Furthermore, the register settings can be applied mechanically, or can be provided by support engineers in a form which can be loaded. However, it is still difficult to get a feel for exactly how the settings will affect the operation of the device, for example the output waveform in the case of a filter. A lot of trial and error is required to achieve the desired effect.

FIGS. 5A to 5E are screenshots 40 and 44 to 47 respectively from another previously-proposed evaluation tool (or “wizard”) for controlling the filter settings of an audio device. This uses a filter characteristics diagram to show the effects of the settings selected. The upper part 41 of each screenshot 40, 44, 45 and 46 contains controls which control which filters are enabled and their current settings. The lower part 42 contains a filter characteristics diagram showing the characteristics of either the currently selected filter or the combination of all enabled filters. The tool also has a register settings panel 48 which lists the corresponding values in the fields which control the equaliser, as shown in FIG. 5E. The engineer then needs to apply these to the device using a separate tool. Finally the tool allows the settings to be applied to a .wav file, generating a modified .wav file which demonstrates the given settings. Thus, it is possible to generate a test file which demonstrates the effects of the filters on a known test signal.

This tool makes it possible to see how the filter characteristics vary with different settings, and how these combine. It is also possible to get the settings which achieve the specified filter characteristics. On the other hand, there is no correlation between the current settings on the device and the settings in the wizard. That is, settings in the tool do not automatically become reflected in the DUT. Thus, the engineer has copy the settings from the software to a different package by hand to apply them to the device and listen to their effects. In addition, the settings are given as field values, but usually it is necessary to write to the DUT an entire register at a time. This means the engineer has to do the arithmetic to merge the settings into the registers by hand. The test file cannot be played back in real time—there is a laborious conversion step.

To summarise, the prior art gives control of individual components, but none of it allows the engineer to configure the device as a whole. This requires the engineer to spend a lot of time thinking about which blocks are involved and spend a lot of time ensuring they get the best out of the device. Likewise, the prior art gives control of the filter components, but a lot of trial and error is required to configure the device to achieve the required effect.

It is an aim of the present invention is to provide an method of, and apparatus for, configuring an electronic device which addresses one or more of the disadvantages mentioned above.

### SUMMARY OF THE INVENTION

According to a first aspect of the present invention, there is provided a method of configuring, through a computer, an electronic device, the device comprising a plurality of functional components, each component having at least one associated control setting, the method comprising the steps of:
the computer displaying the components as blocks of an interactive block diagram of at least one configuration aspect of the device;
the user selecting a component by interaction with the interactive block diagram; and
in response to the selection of a component, the computer allowing the user to set a said control setting associated with the component, and modifying the interactive block diagram to reflect said setting.

In the above method, preferably, the displaying step comprises displaying the interactive block diagram on a display screen of the computer and the selecting step includes the user operating an input device of the computer to move a cursor over the interactive block diagram. Preferably also, the selecting step further comprises the user operating a button of the input device with the cursor placed over the component to be selected.

The above method may further comprise the computer displaying, as part of the interactive block diagram and in proximity to a said component, a control capable of being manipulated by the user to set said control setting associated with the component.

The method preferably further comprises the computer displaying, in response to a cursor being moved over the component and in proximity to the component, a control capable of being manipulated by the user to set said control setting associated with the component.

In response to the user operating a button of the input device with the cursor placed over the component, and in proximity to the component, the method may further comprise the computer displaying a control capable of being manipulated by the user to set said control setting associated with the component.

In either case, preferably, the control is displayed in a graphical form.

In any of the above methods, preferably, each component has at least one possible connection path to other components of the device, a device routing being defined by combining the possible connection paths, each possible connection path being displayed as part of the interactive block diagram. The method may in this case further comprise a step of the user selecting such a connection path. In response to selection of a connection path, the computer may highlight the path in the interactive block diagram.

In addition the method may further comprise, in response to selection of a connection path, adding the path to said device routing if it is not already included, or removing the path from the device routing if it is already included.

Preferably, the computer displays more than one said device routing in different colours in said interactive block diagram.

In one application of the method, the configuration aspect includes signal routing and the interactive block diagram is an interactive block diagram for signal routing within the device.

In another application, the configuration aspect includes clocking and the interactive block diagram is for clocking and PLL settings.

Instead, or in addition, the configuration aspect may include general-purpose input/output, in which case the interactive block diagram can be used for setting general-purpose input/output terminals of the device.

Such applications may be combined in the sense that a plurality of the interactive block diagrams are provided for different said configuration aspects of the device, the method including allowing the user to navigate from one interactive block diagram to another. In this instance, preferably, the modifying step comprises not only modifying the interactive block diagram to reflect said setting but modifying any other said interactive block diagram affected by the setting.

The method of the invention may further involve displaying, as part of the or each interactive block diagram, distinct clock domains of the device.

According to a second aspect of the invention, there is provided a method of configuring, through a computer, a signal processing function of an electronic device, the device providing a plurality of signal processing operations each having at least one parameter requiring configuration by a user and capable of depiction in graphical form, the method comprising the steps of:
the computer displaying one or more interactive setting diagrams showing said at least one parameter requiring configuration by a user in the form of a graphical display;
the user manipulating the graphical display to indicate a desired setting or change in setting of the parameter;
   in response to said manipulation, the computer updating a stored value of the parameter and modifying the graphical display to reflect the updated stored value.

The method of this aspect may further comprise the computer displaying, as part of the interactive setting diagram, a graphical control capable of being manipulated by the user to indicate the desired setting.

In one application of the second aspect, the device is an audio processor and the signal processing functions include filtering of an audio signal.

The interactive setting diagram in this aspect may include at least one filter characteristic diagram with one or more graphical controls which permit the user to indicate a desired setting of the filter characteristic.

Preferably, the device is an audio processor and the signal processing functions include level control of an audio signal.

The interactive setting diagram may include at least one level control diagram with one or more graphical controls which permit the user to indicate a desired setting of the level control.

The computer may provide an audio playback of the audio signal as modified by said signal processing operations.

The methods of the above first aspect and second aspect may be combined such that in response to the user indicating a desired setting or change in setting of a parameter shown on the interactive setting diagram, the computer also modifies the display of the interactive block diagram to reflect the desired setting or change in setting, or vice-versa.

In either aspect mentioned above, the computer may be used to maintain a register map storing values of registers used in operation of said device, wherein in response to the user setting a said control setting associated with the component in the interactive block diagram, or indicating a desired setting of the parameter on the interactive setting diagram, the computer updates the register values to reflect this setting. In addition the computer may maintain a history of operations performed by the user.

The device evaluated by a method of the invention is preferably an audio device, especially a mixed-signal device having analogue components arranged to be controlled digitally. In addition, preferably, the device is a physical device linked to the computer, the method further comprising the computer controlling the device in accordance with the settings made by the user. Such a physical device may be mounted on an evaluation board linked to the computer, in which case the method may further comprise the steps of sensing and display of current passing through specific circuits on the evaluation board.

Moreover, the device may comprise a plurality of registers, the method further comprising a step of the computer controlling the device by writing values to the registers in accordance with the settings made by the user.

Also, a method of the invention may include steps of saving a sequence of operations performed by the user and recalling saved operations for later use. A programming language may be provided for allowing the user to manipulate saved operations.

In any of the above methods, the device may be a device under test and the method may be used to evaluate the device under test. The device under test may be mounted on a development platform, or may be part of an end system. Alternatively, the device is a device under development and the method is used to simulate at least part of the device.

According to a third aspect of the present invention, there is provided an apparatus for configuring an electronic device, the device comprising a plurality of functional components, each component having at least one associated control setting, the apparatus comprising:
control means for generating an interactive block diagram of at least one configuration aspect of the device;
a display for displaying the components as blocks of the interactive block diagram; and
an input device allowing the user to select a component by interaction with the interactive block diagram; wherein
said control means are responsive to the selection of a component by the user to set a said control setting associated with the component, and modify the interactive block diagram to reflect said setting.

According to a fourth aspect of the present invention, there is provided an apparatus for configuring a signal processing function of an electronic device, the device providing a plurality of signal processing operations each having at least one parameter requiring configuration by a user and capable of depiction in graphical form, the apparatus comprising:
control means for generating one or more interactive setting diagrams showing said at least one parameter requiring configuration by a user;
a display for displaying the one or more interactive setting diagrams in the form of a graphical display; and
input means permitting the user to manipulate the graphical display to indicate a desired setting or change in setting of the parameter;
said control means being responsive to said manipulation to update a stored value of the parameter and modify the graphical display to reflect the updated stored value.

A further aspect of the present invention is a computer-readable medium on which is stored a computer program for carrying out one of the above methods.

Embodiments of the present invention can provide a significant improvement in the efficiency of configuring an electronic device being evaluated or configured. This allows the engineer to concentrate on their core task of evaluating the device and optimising or debugging their use of it. It also allows them to develop software to control the device faster, allowing faster time-to-market for development of an end-user product.

There are multiple aspects and embodiments provided in the invention. A first aspect provides an interactive block diagram of the relevant section of the device. A second aspect provides an interactive filter configuration tool for the device which displays the output signal or filter characteristics corresponding to the current settings and allows modification by direct interaction with the diagram.

### BRIEF DESCRIPTION OF THE DRAWINGS

For a better understanding of the invention, and to show more clearly how it may be carried into effect, reference will now be made, by way of example only, to the following drawings in which:

FIG. 1A shows evaluation of a device using an evaluation board controlled from a separate computer;

FIG. 1B is a block diagram of an example device-under-test (DUT);

FIG. 2 is a screen display of previously-proposed register control software;

FIGS. 3A to 3E are screen displays from previously-proposed custom control software;

FIG. 4 illustrates a previously-proposed combination of register and custom control software;

FIGS. 5A to 5E illustrate a previously-proposed filter setting tool, FIGS. 5A to 5D showing screenshots of various possible setting operations and FIG. 5E showing the resulting register settings;

FIG. 6 shows an audio routing block diagram as a first embodiment of an interactive setting diagram according to the present invention;

FIG. 7 shows a clocking and PLL block diagram as a second embodiment of an interactive setting diagram according to the present invention;

FIG. 8 shows a general-purpose input/output (GPIO) block diagram as a third embodiment of an interactive setting diagram according to the present invention;

FIG. 9 shows a filter setting diagram as a fourth embodiment of an interactive setting diagram according to the present invention;

FIG. 10 shows an ALC/Limiter setting diagram as a fifth embodiment of an interactive setting diagram according to the present invention; and

FIG. 11 shows a register map which is provided in an embodiment of the present invention to complement the interactive setting diagrams.

### DETAILED DESCRIPTION OF THE PREFERRED EMBODIMENTS OF THE PRESENT INVENTION

Various embodiments of the interactive setting diagram in accordance with the present invention will now be described with reference to the accompanying drawings, taking an audio IC as an example. As will become apparent, each type of interactive setting diagram is used for controlling a distinct aspect of operation (or “configuration aspect”) of the device. The term “interactive setting diagram” is intended to cover two basic kinds of interactive diagram: block diagrams as exemplified by the first to third embodiments to be described, and signal processing diagrams such as the fourth and fifth embodiments described later. In the first embodiment, the configuration aspect being considered aspect is routing of audio signals within the device.

### First Embodiment

### Interactive Audio Routing Diagram

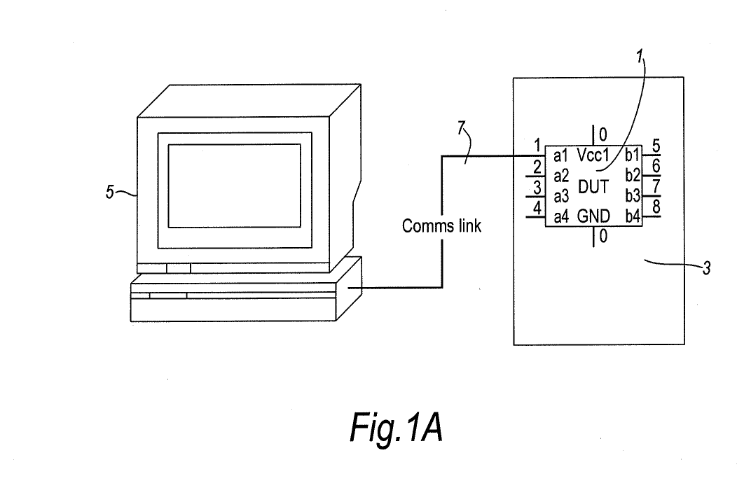

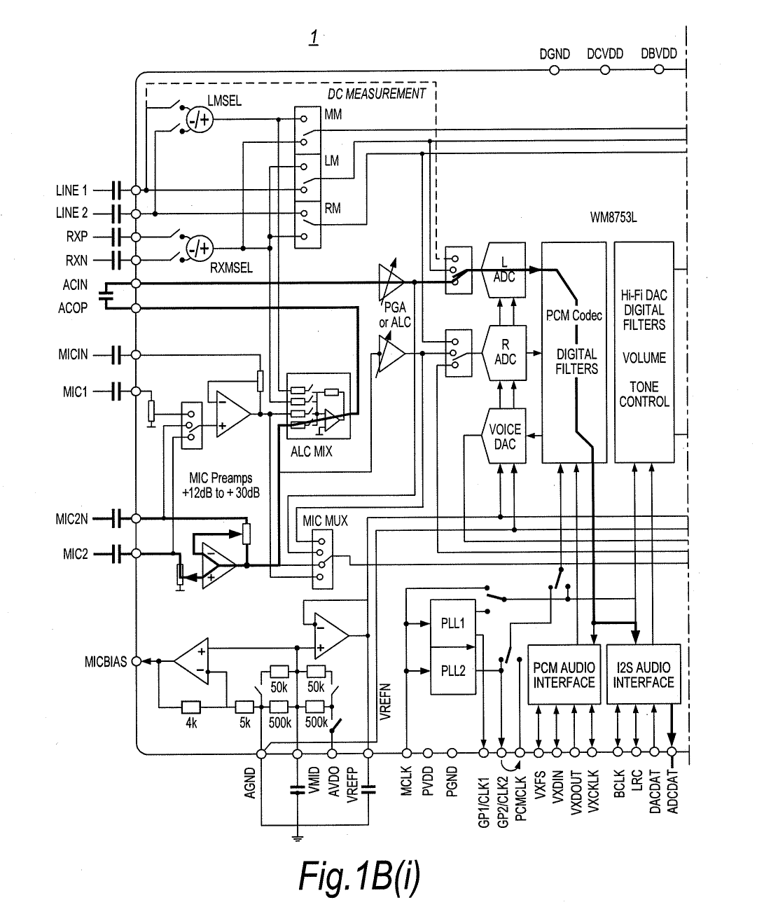

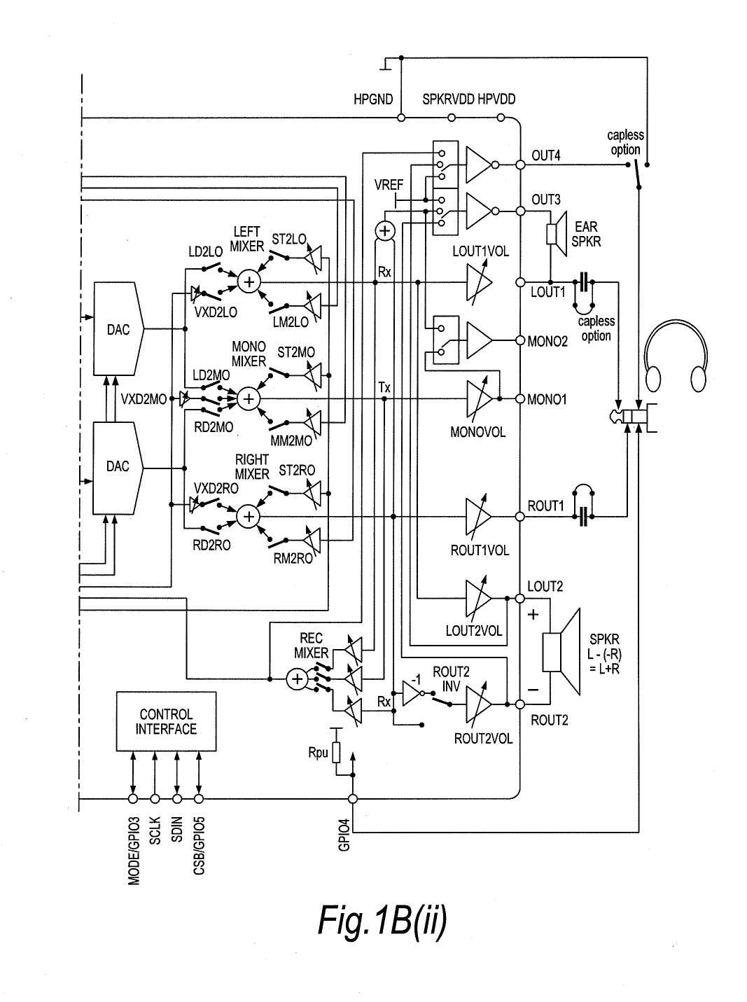

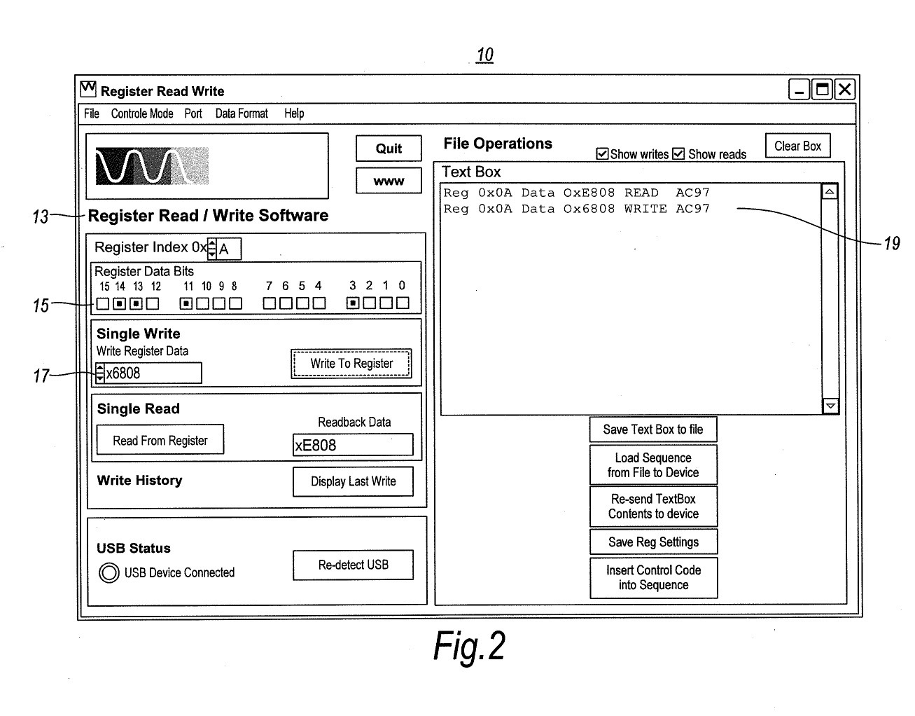

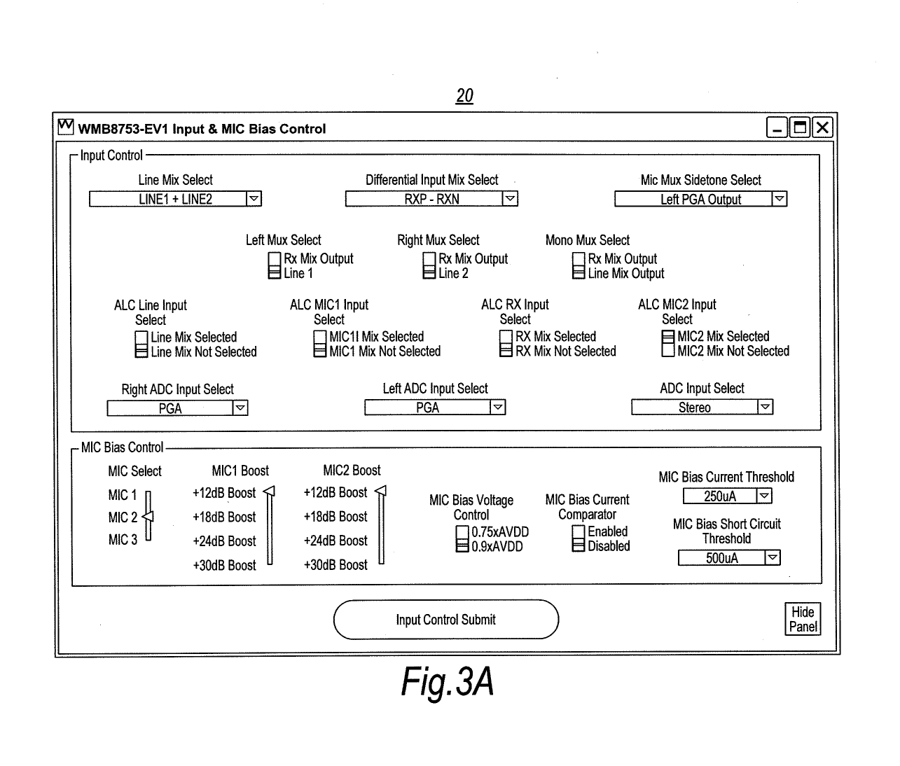

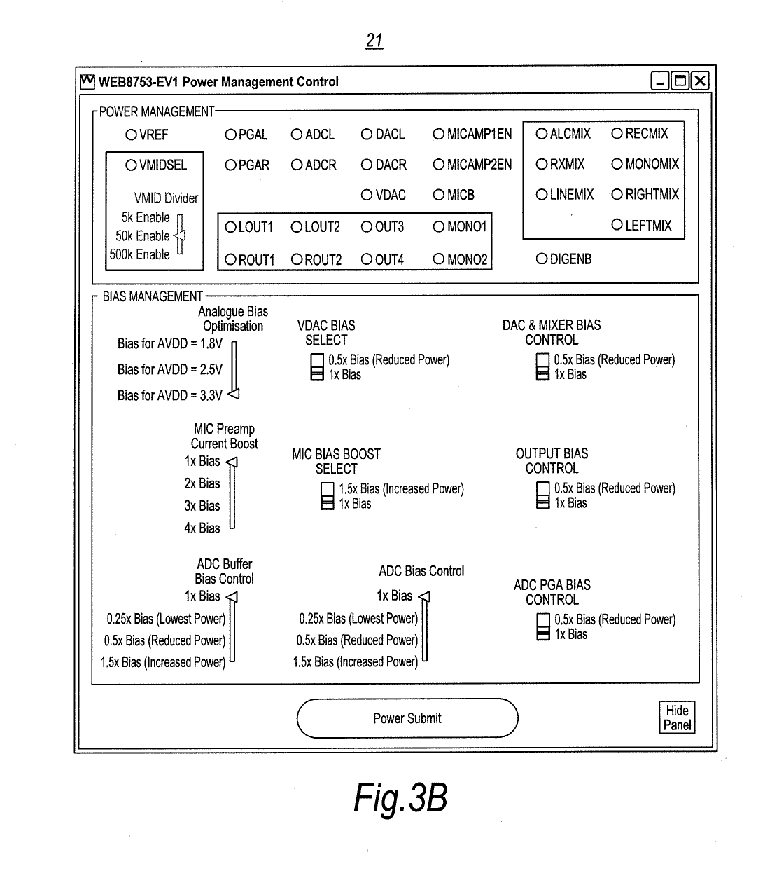

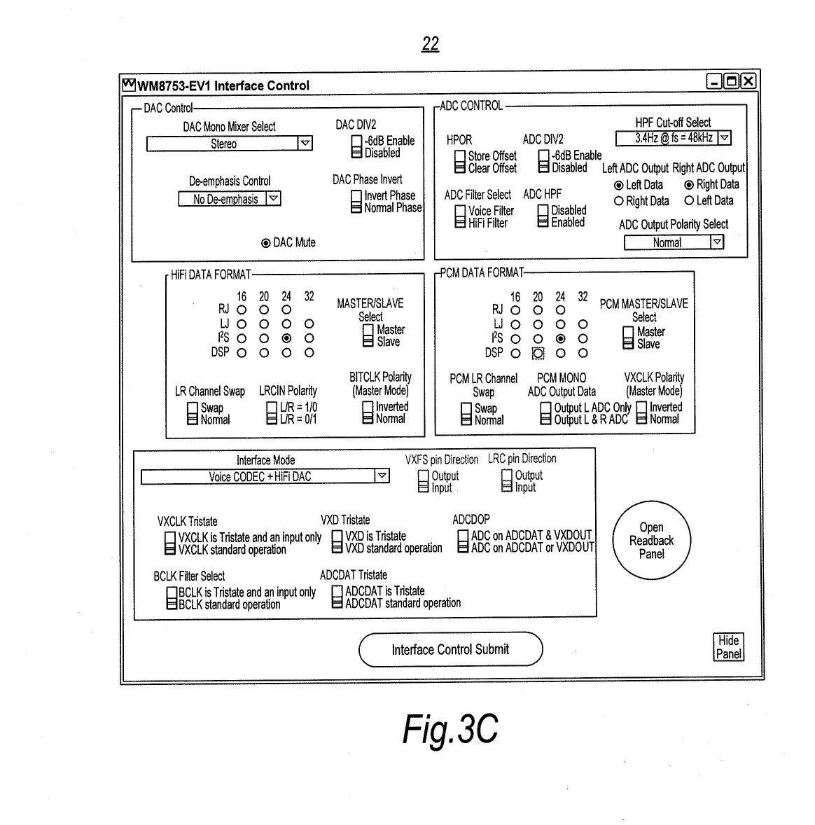

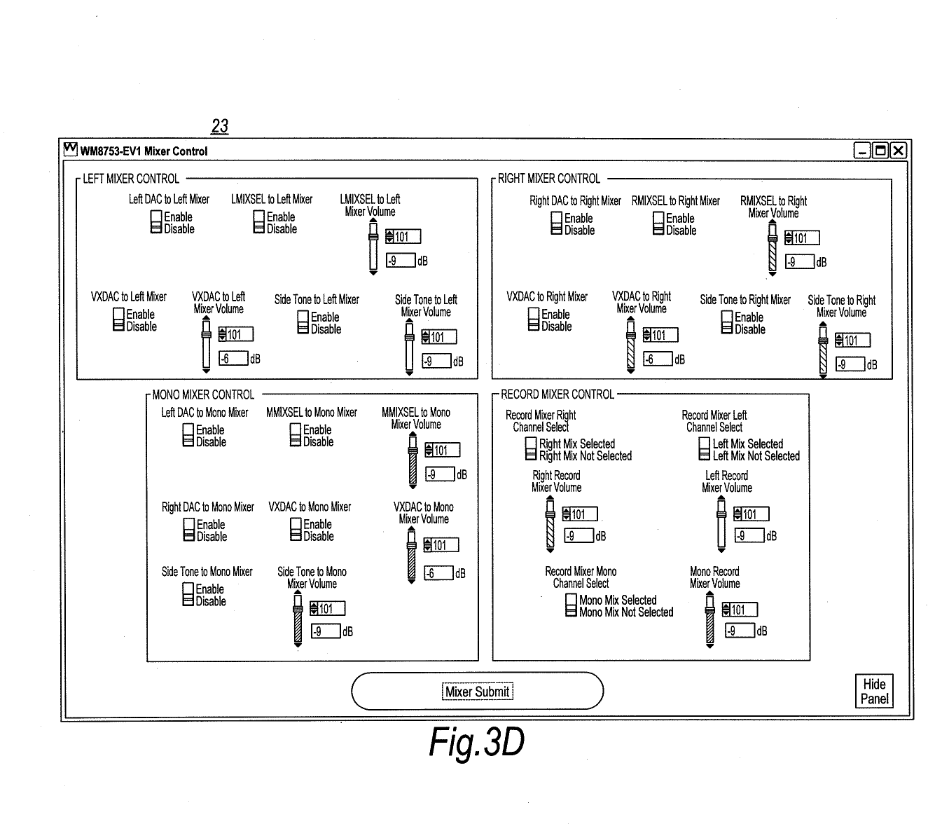

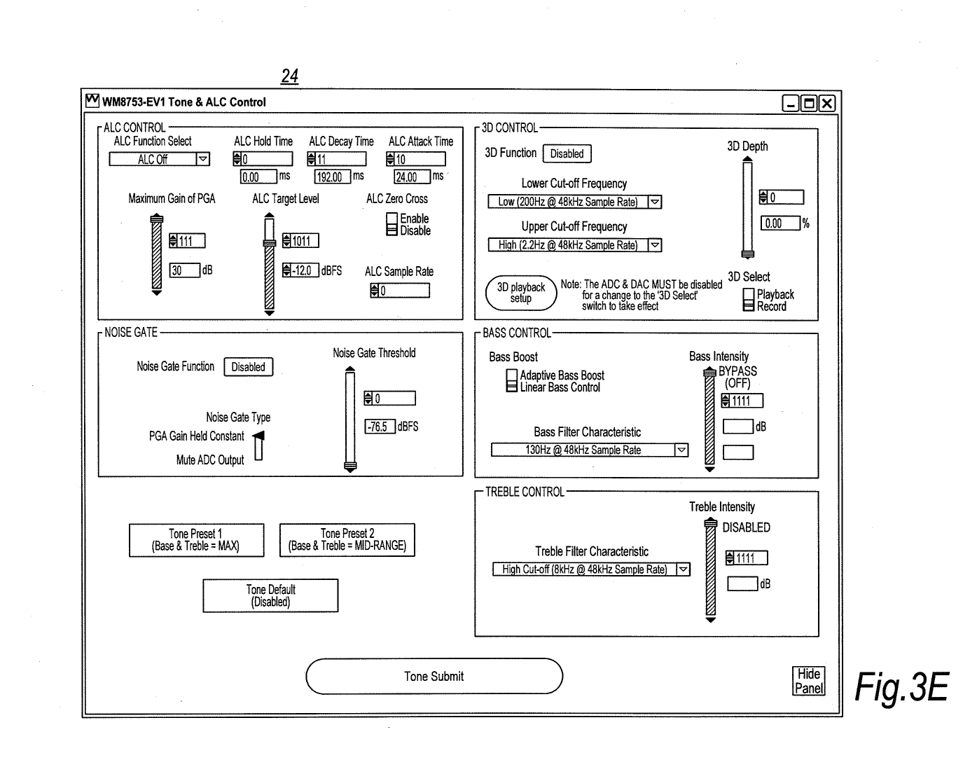

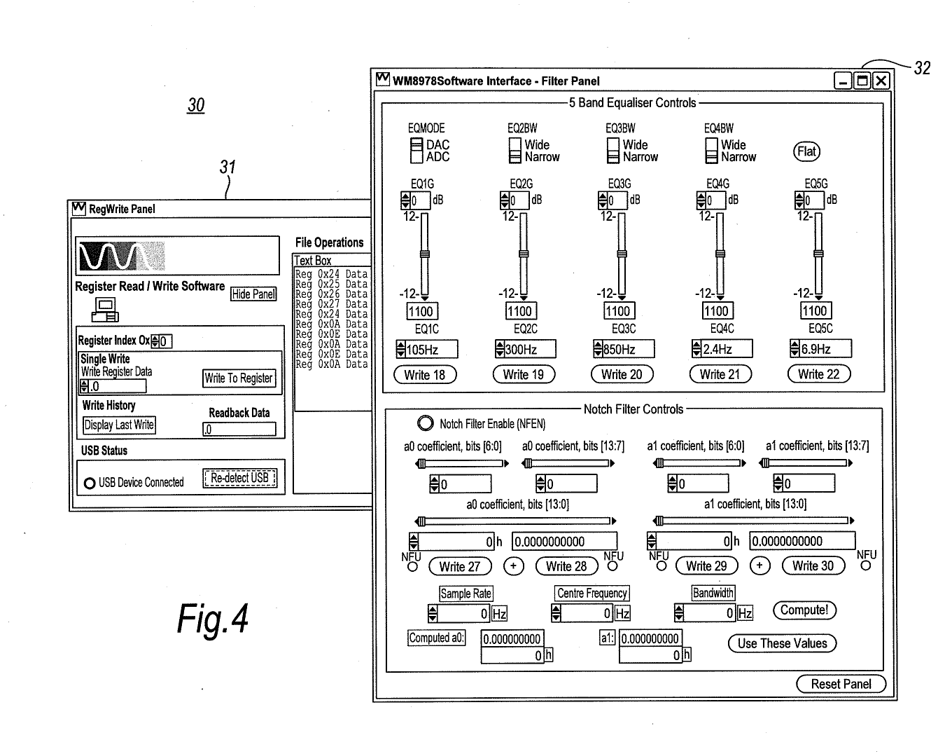

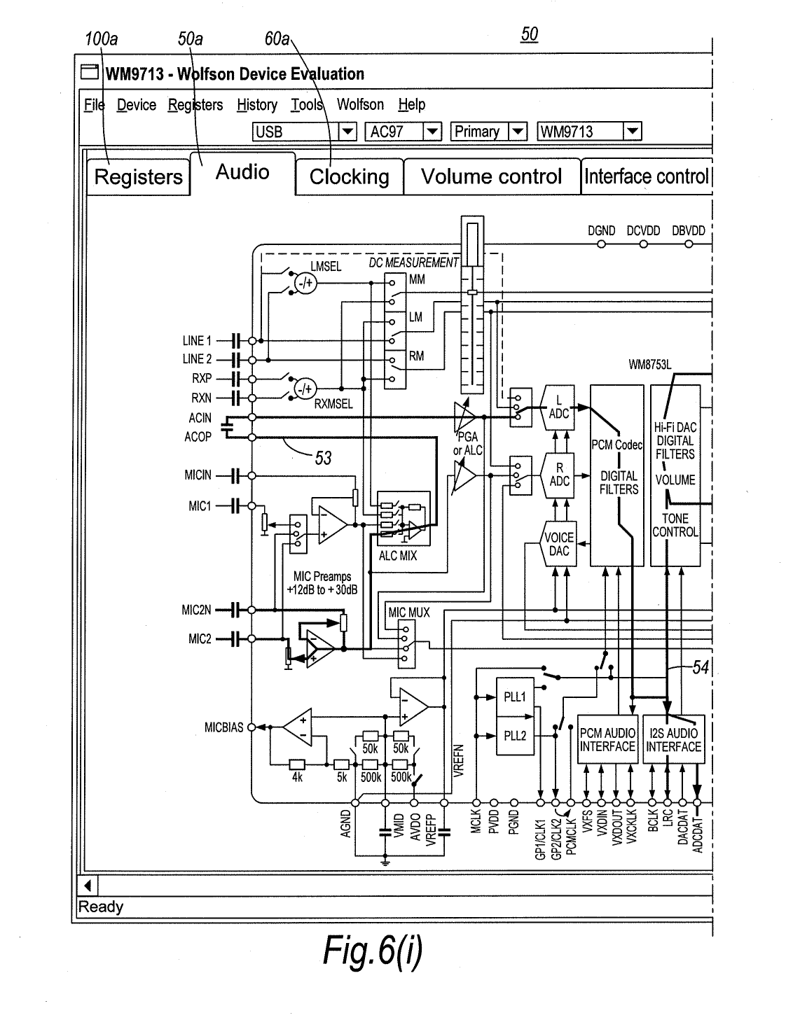

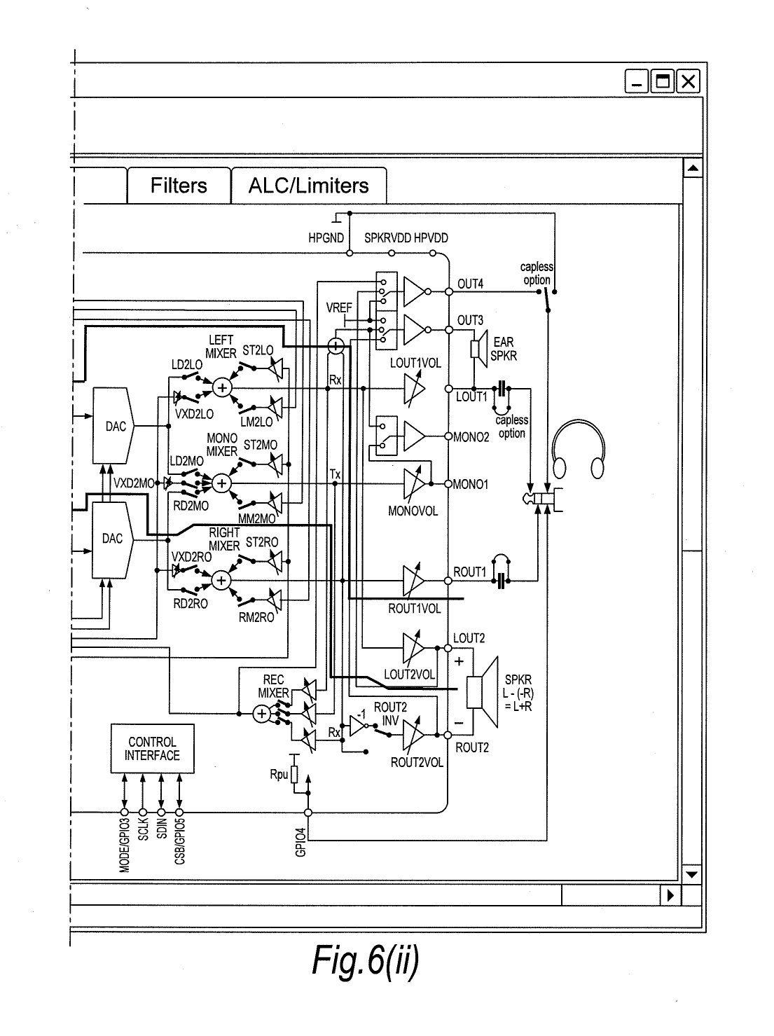

A first embodiment is an interactive audio routing diagram which may take the form, for example, as shown in FIG. 6. This presents, on a screen such as the monitor of computer 5 in FIG. 1A, a block diagram 50 of the main components of the device, in this case the same audio IC as depicted in FIG. 1B. Indeed, the resemblance between FIG. 1B and FIG. 6 will be noted. The difference now is that the diagram 50 is interactive, allowing a user (typically, an engineer) to select components and connections between them in order to set up a particular routing. Typically, this will be achieved by the user operating an input device such as a mouse, operated in known ways for interacting with a graphical user interface of a personal computer. For example, in a windowing-type environment, tabs can be used to switch between different windows. As will be seen in the Figure, the interactive block diagram 50 is selected by means of a tab 50a. The screen display includes other tabs 100a, 60a etc. along its upper edge, providing access to diagrams for handling other aspects of the device operation, as will be explained later.

FIG. 6 shows bold lines 53, 54 where a particular signal paths have been selected (for example, by clicking a button of an input device connected to the computer displaying the diagram). The lighter-coloured bold line 53 defines the input path for recording through differential microphone inputs MIC2 and MIC2N, through an ALC/mixer component of the IC, via a programmable gain amplifier (PGA) providing amplification or attenuation, to an ADC of the device from which the signals (now in digital form) pass through a digital mixer before being made available at a PCM and/or I2S interface. The darker-coloured line shows a playback path from the audio interfaces, through circuitry for digital filtering, volume and tone control, via DACs to an analogue mixer stage, then to output amplifiers and the output speaker terminals LOUT2, ROUT2. Of course, the display would in practice normally be in colour, allowing the different paths to be drawn in different colours, and assisting the user to debug routing and crosstalk issues.

Where path components have additional control over and above routing (for example the amplification or attenuation on PGAs), these are shown as overlaid controls or text boxes. These can either be fixedly displayed, floating, or preferably (to reduce clutter) shown only when the user selects or hovers over the relevant component. In FIG. 6, the user has selected the PGA on the input to the left ADC, popping up a slider to control the amplification across the PGA.

In this embodiment, paths can be selected by clicking directly on the connection wiring in the block diagram; clicking on a path section enables or disables it. Paths can also be selected by dragging an audio source (e.g. an input, a mixer or a DAC) to an audio sink (e.g. an output, mixer or ADC), with the software calculating and enabling the best path to route that source to that sink. The enabled paths are instantly visible, and it is instantly visible where enabling one path disables another. If a section of a path is missing, this is instantly visible, aiding debugging of configurations.

To provide the above-mentioned additional control, or as an alternative (perhaps to provide more advanced functions), double-clicking on a path component may bring up a pop-up window which allows that component to be controlled as appropriate. Path components are controlled in a form appropriate to their content. For example:—

Values can be entered directly into a text window.

Single-bit toggles can be rendered as buttons, which can be set either out (0) or in (1), or as checkboxes, which can be either empty (0) or checked (1).

Ranges may be represented by sliders, either from 0 to the maximum value, or with a value appropriate to their real meaning (e.g. −6 dB for a volume slider). By clicking on the slider with an input device and dragging, the slider can be set to the desired point.

Muxes can be represented as a switch which points to the currently selected path.

Mixers can be shown with a group of sliders and check boxes to control the signals which are enabled through the switch and the gain or attenuation which is applied to each signal.

Inputs can have a peak signal level which can be used to check for clipping (caused by signals louder than 0 dBFS).

The above list is not exhaustive, and other possible representations for the block controls will occur to those skilled in the art, following the principle that the representation gives access near to the relevant item in the block diagram for easy and intuitive setting. As will be apparent, depending on the type of control provided, a “setting” by the engineer will often be a change in an existing or default setting. The term “setting” in the claims is thus to be interpreted to include changes of setting. User interaction with the above additional controls and/or pop-up windows can be performed in a variety of ways as appropriate to the type of control needed.

Fields can also include some text to indicate their purpose and/or meaning. The control values can be updated by direct interaction with the register map display. For example: The register value or field value can be edited as a text field. Single bits represented as buttons can be clicked on to depress or release them. Ranges represented as sliders can be dragged to new positions to update the values. Values represented as drop-down lists can be selected from the list. Further or more detailed information can be provided via tooltips, which appear when hovering the mouse over an area of the register map.

Additional operations can be offered when an item is selected, for example by providing a menu when an item is clicked on with the second mouse button of a two-button mouse (“right-clicked”). This menu of additional operations, as well as including the default action above, can include saving the current state of the item, restoring a previously saved state, highlighting the sources of signals input to this item, highlighting the destinations of signals originating at this item, enabling or disabling the item, viewing the register settings associated with the item, and so on.

As will be obvious to those skilled in the art, alternative methods of input can replace or supplement the interaction methods described above without materially affecting the end result. For example, keyboard navigation can be implemented whereby item selection is achieved using the cursor keys, the tab key, or any other appropriate set of keys to navigate around the block diagram, and item controls are invoked by pressing the return key, the space bar or another appropriate key when the item is selected. Alternatively, a touch screen may be employed allowing the user to interact directly with the interactive block diagram.

Underlying the interactive block diagram is software which stores an internal representation of all the components, how they are connected and how the settings affect the connections. The software can enable and disable components based on whether they are included in selected paths. It can detect incomplete paths and unused components and either highlight them or power them down automatically. Thus, the software can help the user achieve the lowest power settings for their desired configuration by disabling unused components. The user can learn how the routing works and how the various components are inter-related by experimenting and getting instant feedback.

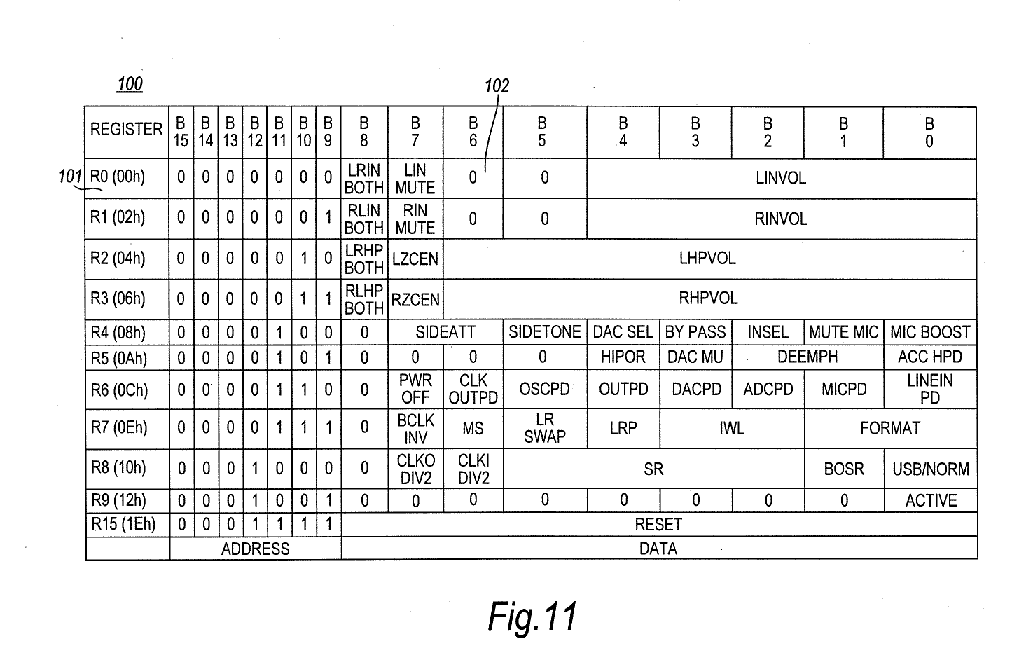

Either immediately or after the user has finished interacting with the interactive block diagram, the software converts the settings made into register writes to implement the desired settings on the device. The generated series of register writes will be optimised for best performance for the user. Should the user wish to review or edit the register settings, a tab 100a in FIG. 6 allows the user to navigate from the interactive block diagram 50 to a register map 100, an example of which is shown in FIG. 11 as an illustration.

The software can hold the optimum power-up and power-down sequences, allowing the paths to be converted to the best series of register writes to minimise artefacts (such as pops and clicks).

As already mentioned, different aspects of the device operation are preferably handled by separate interactive block diagrams. However, even a single aspect such as the audio routing shown in FIG. 6 may more conveniently be covered by multiple block diagrams. Thus, detailed routing for individual blocks (e.g. the inputs) can be configured in a separate dedicated interactive diagram which includes only the components relative to that block. This allows the currently configured paths to be seen clearly and quickly, making the settings easy to interpret and update. It therefore becomes easier to achieve the desired routing, without referring to the datasheet, saving time and reducing context switching for the engineer.

More generally, since updates are made by interacting directly with the representation of the device, this allows a consistent metaphor and allowing a very natural interaction. Because the updates are conceptually made directly to the device, and not to individual components (as is the case in the previous proposals), the user requires fewer steps to achieve the same modifications. Users can see instantly which components are involved in the path, minimising the burden on them and speeding up their work.

As a preferred extra feature, the software records a history of operations which can be used for developing software. The history can be saved and replayed at a later date, allowing a series of steps to be reproduced, which is useful for developing setup sequences or debugging problems.

Another refinement of the above embodiment concerns a problem of ensuring that register values, generated by the software, are actually reflected in the DUT.

To explain this problem, some devices under test only support writing to their registers. Such systems require the user to store (or “cache”) the last-written value for each register, so that this value is ready for use when making subsequent updates. When the last-written value is cached, a situation can arise where the device under test holds a register value which is different to that stored in the cache, for example if another application has written to the device independently, or if the device has been reset to default values without also resetting the cached values. Such cached values are therefore less trustworthy than values which have been read directly from the device. Therefore, when making changes to register values, it would be desirable to know how data bits correspond to data fields, which data fields can be modified and which can be trusted. Also, when performing debugging operations, it is particularly important to be aware of which settings have been read from the device and can be trusted, and which settings have come from a cache and hence may be incorrect.

Thus, the software may also provide a register map giving information about the actual state of each register value and field of the device under test, to make clear to the user whether changes to settings have actually been submitted to the device or are still pending. In this way, changes can instantly be associated with register fields, since they will be highlighted as pending changes in the register map.

By adding such a register map, it becomes clear what the default setting is, and changed values are highlighted. This has benefits for debugging issues—it restricts the settings which need to be investigated. It also has benefits for developing software sequences as it highlights the registers which have been altered to achieve the current state.

Although not shown in FIG. 6 for simplicity, a further refinement of the interactive block diagram is to indicate the current peak signal (voltage) level at each point in the circuit for a given level of input signal, for example by displaying relative signal levels along a path section (e.g. +6 dBFS, −4 dBFS where dBFS=decibels relative to a full-scale signal). These signal levels can be based on a full-scale signal, or on the peak signal level of the sections inputs. This makes it easy for the user to see where the settings risk signals exceeding full-scale, which would lead to clipping and audio artefacts. The desired output signal levels are easier to set, and it is clear how the signal levels at one point in the circuit affect other signal levels. Context-sensitive help can also be implemented, which takes the user to the relevant section of the datasheet for any chosen item in the diagram.

An extension of the above idea is to provide Current Monitoring of a physical device under test. For mobile applications, power consumption in various scenarios is of great concern. This can be difficult to calculate and there is no substitute for real measurements. However, it is not always obvious how best to achieve this, and it can require a complicated setup. When evaluating a DUT in the arrangement of FIG. 1 for example, a sense circuit on power supply of interest on the device can be fed into an ADC which can be interrogated from the evaluation software. This information can be presented visually in various styles (e.g. simple current value, ammeter-style needle, graph), for example on an interactive block diagram like that of FIG. 6. In addition, or alternatively, such current data may be stored for processing later (either by the software or in a separate analysis tool such as Excel).

Clocking of the DUT is dealt with in a separate interactive block diagram as explained below. However, in the case of an audio device, one aspect of clocking has an effect on the audio signal and is thus relevant for audio routing. A clock domain is an area of circuit which is derived directly from the same clock source. One common issue when using parts which have multiple clock sources is that signals which cross clock domains will suffer from artefacts such as a regular ticking sound. To help debug issues such as these, the software can highlight the different clock domains on the routing circuit (e.g. with a different colour of shaded overlay), making signals which cross domains instantly obvious.

Likewise, various components in the audio routing alter the phase on the input signal. For instance, many amplifiers also invert the signal, and many outputs have inverters (either optional or hard-wired). It can be important to ensure that the phase of two different but related signals output from the device is the same. To help ensure this, the software can indicate the current phase at relevant points in the circuit. This makes it easy to see where the signals get inverted and clarifies how the phase at one point in the circuit affects other signal phases. In this way, it becomes easy to arrange for the output signals to have the desired phase.

### Second Embodiment

### Interactive Clocking/PLL/FLL Diagram

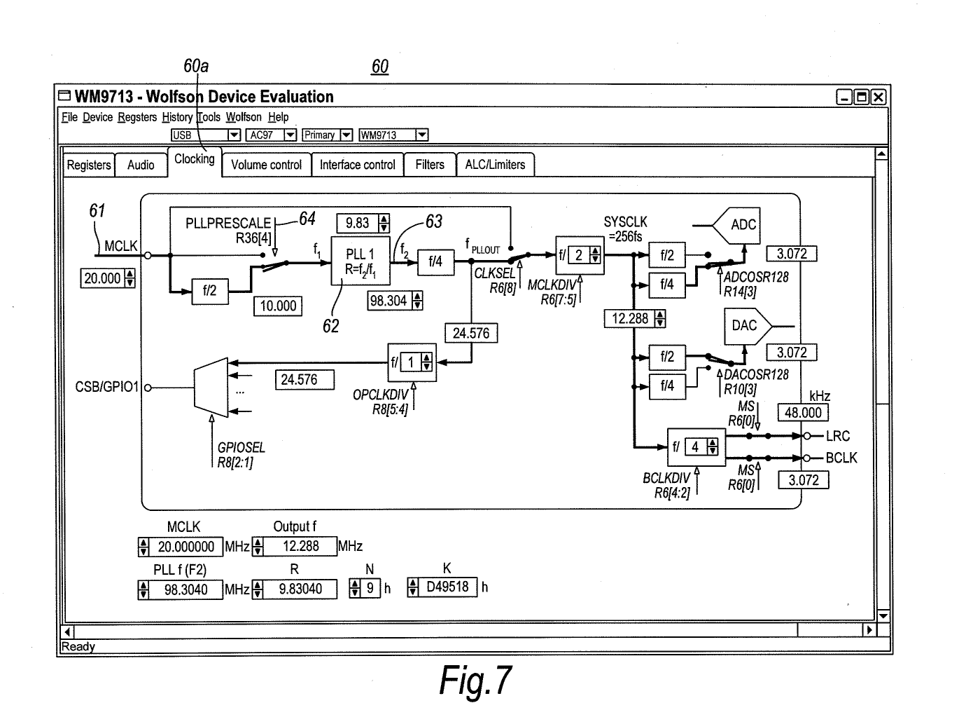

As already mentioned, there are various aspects to the operation of a complex electronic device. In the case of an audio IC, for example, audio routing as illustrated in FIG. 6 is only one aspect. Another configuration aspect is the clocks applied to various parts of the IC. FIG. 7 illustrates a second embodiment of the present invention in which an interactive block diagram 60 is provided to handle configuration of clocks (such as master clock MCLK 61), phase-locked loops (PLLS, such as PLL1 62) and/or frequency-locked loops (FLLs) of an electronic device. The interactive block diagram 60 is selected, for example, by clicking on a tab 60a for Clocking, located along the upper edge of the screen display. Thus, a user can proceed directly from another interactive block diagram, such as interactive block diagram 50 for audio routing as already discussed, to the present diagram 60 to configure the clocks, PLLs and FLLs.

This interactive block diagram presents the current settings as routing and frequencies on a conceptual diagram of the relevant section of the device. The settings can be altered by direct manipulation of the diagram. The diagram allows many of the values to be directly editable, with the rest of the circuit updating to match, and the signal lines (e.g. 63 in FIG. 7), switches (e.g. 64) and so on change their appearance to reflect the current settings.

This, in this embodiment, switch settings are altered by, for example, clicking directly on the block diagram with a mouse, and the frequencies and settings at different points in the circuit can be manipulated directly, with the rest of the circuit updating appropriately. More specifically, variable dividers are controlled by direct manipulation of the divider value, as illustrated for the case of PLL1 for which a ratio of 9.83 is currently set.

The currently active paths are highlighted, and enabled paths are instantly visible as indicated by the thick line 63 in the Figure. As in the first embodiment, further or more detailed information can be provided via tooltips, which appear when hovering the mouse over an area of the register map.

To enable the above interaction, the software has an internal representation of all the components, how they are connected and how the settings affect the connections. The software can enable and disable components based on whether they are included in selected paths; in addition, it can detect incomplete paths and unused components and either highlight them or power them down automatically. This may of course affect the active components in another block diagram such as the audio routing diagram of FIG. 6. The software makes the necessary changes automatically as necessary.

Consequently, similar effects are obtained as in the first embodiment. The currently configured paths can be seen clearly and quickly, and the settings are easy to interpret and update. It is easy to select and update the paths to achieve the desired output frequencies, without referring to the datasheet, saving time and reducing context switching for the engineer. Updates are made by interacting directly with the representation of the device, providing a consistent metaphor and allowing a very natural interaction. It is easy to see the relation between components and their controls, and easy to see the relationship between different parts of the clocking circuit. Therefore, users can see instantly which components are involved in the path, minimising their memory load and speeding up their operation. The user can learn how the clocking architecture works and how the various components are inter-related by experimenting and getting instant feedback. Because the updates are conceptually made directly to the device, and not to individual components (as is the case in the previous proposals), the user requires fewer steps to achieve the same modifications.

Referring to more clocking-specific issues, the software can help the user achieve the frequencies for their desired configuration. Distinct paths can be drawn in different colours, helping debug clock domain issues.

Once the user has configured the clocking, PLL and FLL components to his or her satisfaction, the software generates from the resultant settings a series of register writes optimised for best performance for the user. The user can then proceed to a different configuration screen, such as an interactive block diagram for GPIO discussed below.

The above-mentioned additions of a history of operations, register map, and highlighting of different clock domains, described for the first embodiment, can be advantageously applied here also.

### Third Embodiment

### Interactive GPIO Diagram

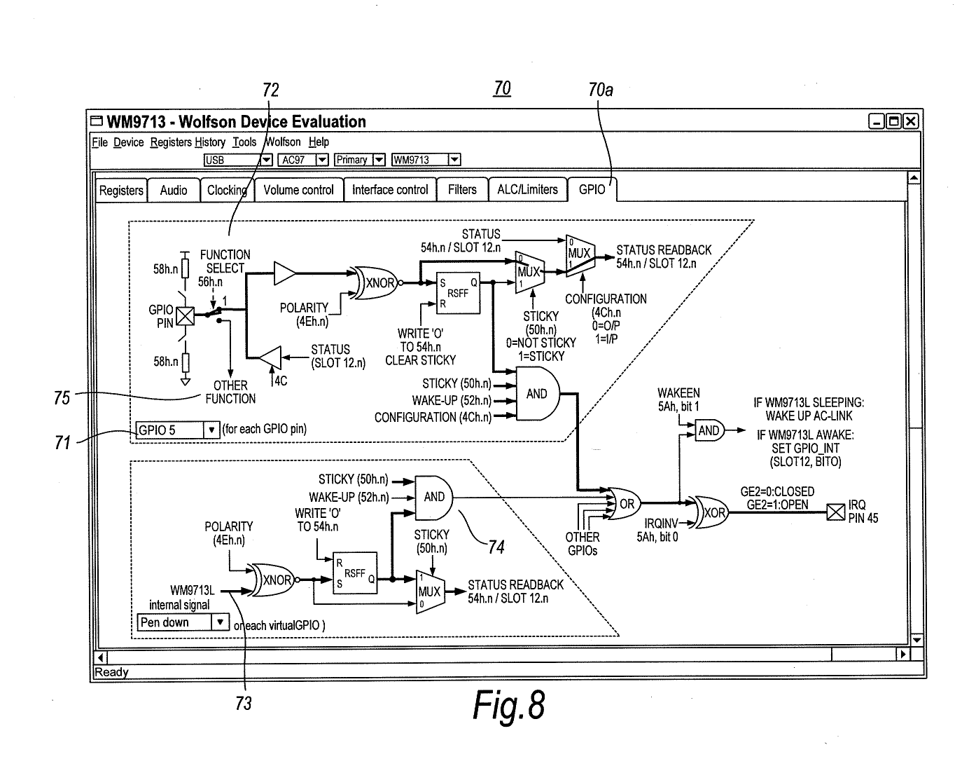

Some devices have multi-function or general-purpose inputs and outputs (the term “GPIO” will be considered to cover both), with quite complex control hierarchies. Continuing with the example audio IC used previously, FIG. 8 shows an interactive block diagram 70 for general purpose I/O configuration as another embodiment of the present invention. The user can select this diagram for display by clicking on a tab 70a. The example shown allows configuration of a single GPIO pin of the device; in this instance GPIO 5 has been selected (as indicated by 71).

This embodiment applies the same principles of direct interaction and manipulation to the GPIO diagram. Thus, switch settings (such as FUNCTION SELECT 72 in FIG. 8) are altered by clicking directly on the block diagram, and the currently active paths are highlighted and enabled paths are instantly visible.

Corresponding features and effects are provided as for the first embodiment and the second embodiment.

Focussing on I/O issues, firstly, the software can detect incomplete paths and unused components and either highlight them or power them down automatically. The inputs to the various sections of the circuit are controlled directly. It is easy to select and update the paths to achieve the desired outputs, without referring to the datasheet, saving time and reducing context switching for the engineer.

Secondly, distinct paths can be drawn in different colours, helping debug issues. It is instantly clear where signals are stopped, directing the user towards the settings which must be altered in order to enable the signals they desire. For example, the interactive block diagram of FIG. 8 shows that the pen down signal path 73 stops at the AND gate 74. It is instantly obvious that WAKE-UP is not enabled on the input to this gate, blocking the propagation of the signal. Hence, the user can learn how the GPIO architecture works and how the various components are inter-related by experimenting and getting instant feedback.

There are typically multiple GPIOs in a device. FIG. 8 shows an interactive block diagram of the internal circuitry relevant to GPIO 5 and a Pen down virtual GPIO in the example audio IC. An overview diagram (not shown) can be selected by the user to display all the GPIOs simultaneously, allowing the user to see how the different GPIOs interact. A GPIO can then be selected to bring up the detailed diagram as in FIG. 8, configured, and then the user can return to the overview.

Typically GPIOs can have multiple sources or sinks selectable by the user. For example, GPIO pin 2 might output the direct value controlled by the user, or a clock, or the pendown status of the touch panel, or the current voltage on a DC/DC converter. In FIG. 8 this is represented by the “OTHER FUNCTIONS” line 75 on GPIO 5. This section can be expanded to allow the user to select which function the GPIO should serve.

As before, a history of operations, register map, and highlighting of different clock domains can be provided.

Three different embodiments of an interactive block diagram have been explained above, but the same principles can be applied to any section of the device which can be described diagrammatically. Other examples include current converters (LDOs, DC/DCs), auxiliary voltage monitors, interrupt sources, and current sinks.

The first to third embodiments all provide interactive block diagrams as an intuitive way to facilitate user configuration of a device at a functional block level. Thus, they assist the engineer in setting up connections between components of a device, whether they be physically separate circuits or not, so long as they are conveniently thought of as distinct blocks. Other aspects of operation of an audio IC concern not so much the relationship of functional blocks but more the audio processing at a conceptual level. To cover such aspects, further embodiments of the present invention provide interactive diagrams other than block diagrams.

### Fourth Embodiment

### Interactive Filter Diagram

One important part of audio processing is filtering.

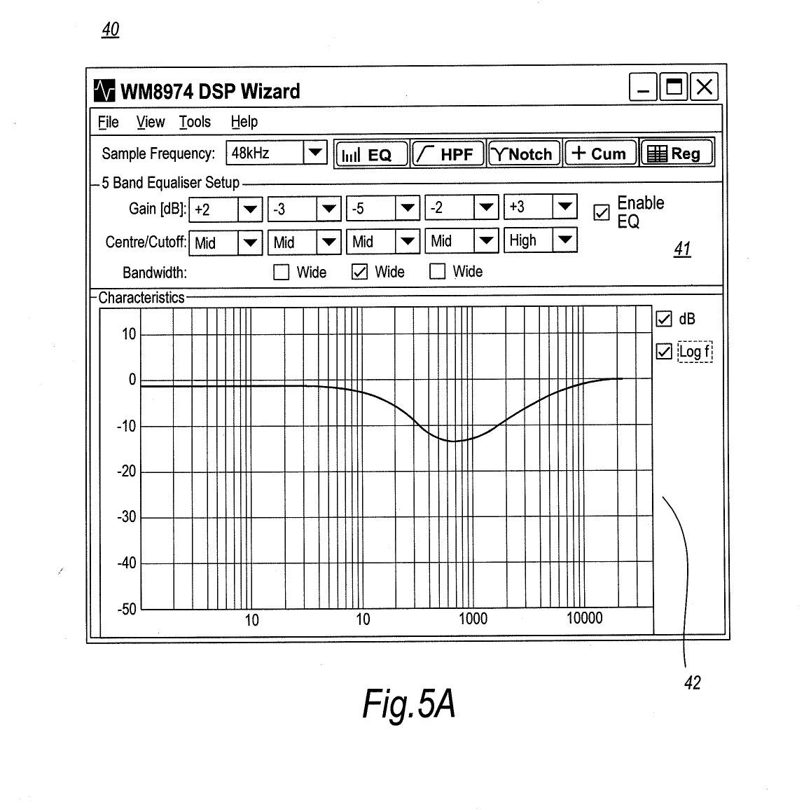

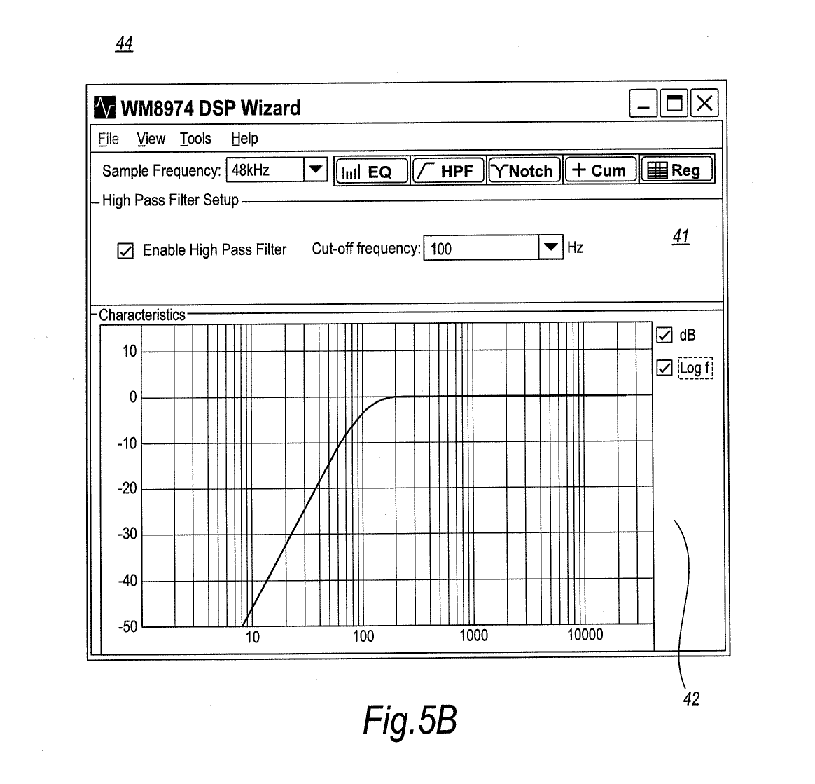

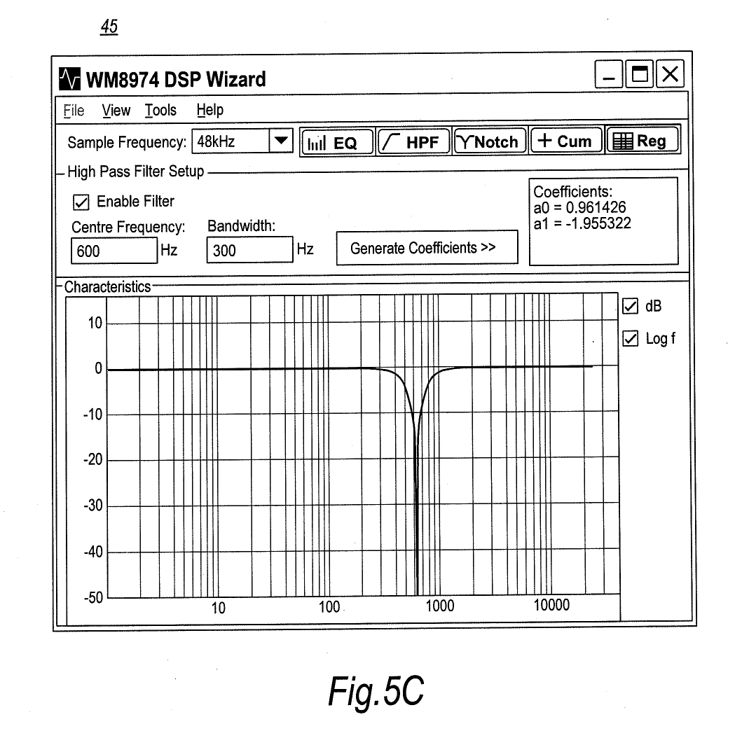

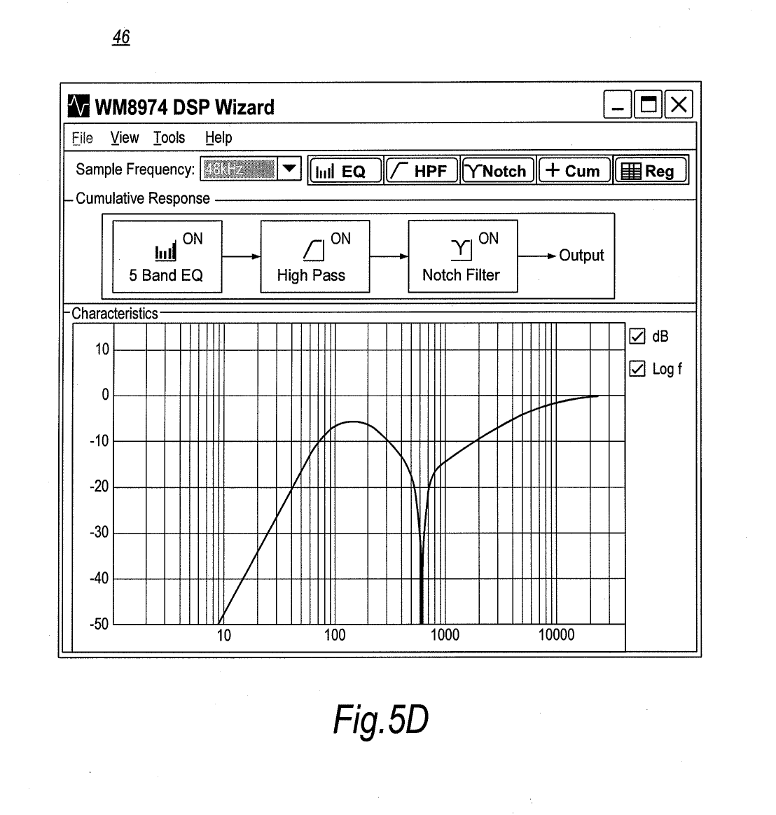

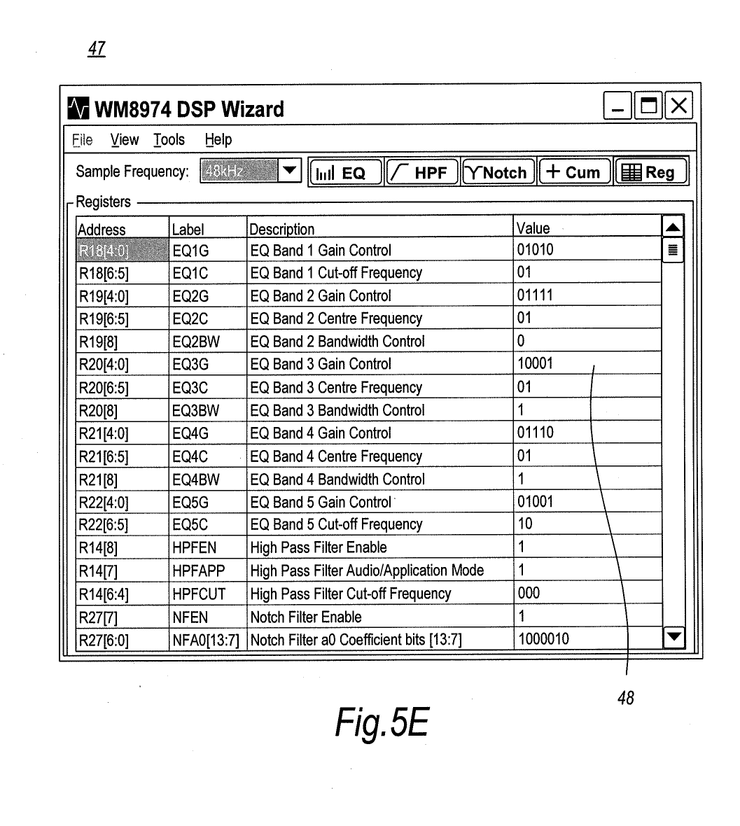

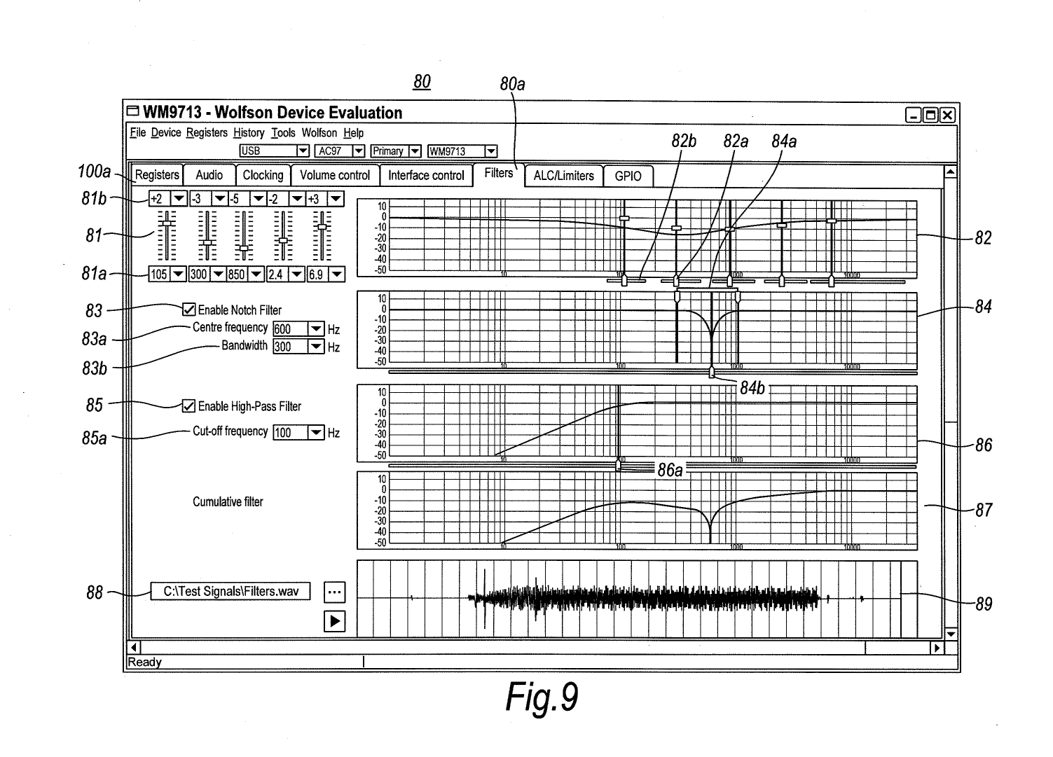

FIG. 9 shows an interactive setting diagram 80 as a fourth embodiment of the present invention, for setting filter characteristics. This presents the current settings using filter characteristics diagrams similar to those shown in FIGS. 5A to 5D. The difference in this embodiment is that the filter settings are overlaid onto the diagram and can be manipulated directly, with the result being instantly visible in a cumulative diagram and potentially instantly audible via the device.

As in the previous embodiments the interactive setting diagram will typically be displayed on a display device of a personal computer operating under a graphical user interface, allowing familiar techniques to the user such as mouse-clicking, drag-and-drop, and so on to be employed for manipulating the interactive setting diagram.

Note that the interactive setting diagram 80 can be selected by clicking on a tab 80a available from any of the screen displays shown in FIGS. 6 to 8 for example, and thus can be employed in conjunction with any of the other interactive diagrams already described. In other words, this interactive setting diagram is provided by the same device evaluation software used to manage the interactive block diagram(s) like FIG. 6, 7 or 8. The settings are taken from the current settings held in the software for the device, and changes made to these settings are reflected back to the other settings in other diagrams available via the other tabs. This includes the register map panel 100 (see FIG. 11) accessible via the “Registers” tab 100a, allowing the corresponding value changes to be determined easily.

In the example shown, the interactive setting diagram provides a five-band equaliser having sliders 81, each of which has an associated centre frequency shown at 81a, and a level value shown at 81b. The effect of this equaliser is shown on the graphical display 82. Note also that slider controls 82a and level markers 82b, corresponding to each of the equaliser bands, are displayed underneath this graphical display 82.

Below the equaliser is depicted a notch filter which is enabled via a selector 83, and which has parameters of a centre frequency and bandwidth as shown at 83a and 83b respectively. The notch filter characteristic is shown in graphical display 84. Again, the notch filter is also represented by a sliders on the graphical display, in this case a pair of sliders 84a for bandwidth and a slider 84b for centre frequency.

A further filter available in the audio IC used in this example is a high-pass filter, enabled via selector and having a cut-off frequency indicated at 85a. A graphical display 86 shows the filter characteristic and a slider 86a along its lower edge shows visually the position of the cutoff frequency.

A fourth graphical display 87 shows the cumulative effect on an audio signal of the above five-band equaliser, notch filter and high-pass filter. Finally, a test signal can be selected at 88 and its waveform displayed to the user in waveform display 89.

To use this interactive setting diagram, equaliser bands 81 can be selected on the graphical display 82 by dragging (with an input device such as a mouse) the corresponding slider 82a left and right across the frequencies, with instant feedback in the diagram. Equaliser levels are selected by dragging the marker 82b up and down on the diagram, with instant feedback in the diagram. The notch filter centre frequency can be selected by dragging the corresponding slider 84b left or right in the diagram, again with instant feedback in the diagram. Notch filter bandwidth is selected by dragging either of the upper frequency or lower frequency sliders 84a left or right in the diagram, with the opposite slider mirroring and instant feedback in the diagram. The high-pass filter cutoff frequency is selected by dragging the corresponding slider left or right in the diagram, with instant feedback in the diagram.

The cumulative filter response is updated as settings change, and as filters are enabled and disabled. The software calculates the corresponding filter coefficients and updates the settings on the DUT as appropriate. This includes reflecting any changes on other interactive block diagrams or interactive setting diagrams. For example, setting all equaliser bands to the “flat” position may allow a component of the device, responsible for providing the equaliser function, to be disabled, and this is reflected on an interactive block diagram like that of FIG. 6, so that if the user refers to that diagram, an up-to-date configuration is displayed.

As an alternative to interacting with the graphical display of filter characteristics as described above, the user can if preferred enter settings by hand from drop-down lists available by clicking on the down arrows next to values 81a, 81b and so forth, as is conventionally known.

By selecting an available file in window 88, a test signal is displayed and can be played audibly to hear the effects of the filter, as well as being shown pictorially in waveform display 89.

Alternatively, the corresponding settings can be applied directly to the device and the effects can be heard directly through the device.

Thus, the various filter components and the cumulative effect can be seen clearly and quickly, and the settings are easy to interpret and update. The filters' effects can be heard as well as seen. It is easy to select and update the settings to achieve the desired effect, without referring to the datasheet, saving time and reducing context switching for the engineer.

Updates are made by interacting directly with the representation of the filters, providing a consistent metaphor and allowing a very natural interaction. Users can see instantly which filters are available, minimising their memory load and speeding up their operation. The user can learn how the filters work and how the various filters are interrelated by experimenting and getting instant feedback. The user only needs to work in units which make sense—frequencies and decibel levels—rather than in terms of abstract filter coefficients.

As in the previously-described embodiments it is possible to add a history of device operations, which can be used for developing software. The history can be saved and replayed at a later date, allowing a series of steps to be reproduced; this is useful for developing setup sequences or debugging problems.

A register map such as that illustrated in FIG. 11 can be used to show the state of each register value and field of the device.

### Fifth Embodiment

### Interactive Automatic Level Control

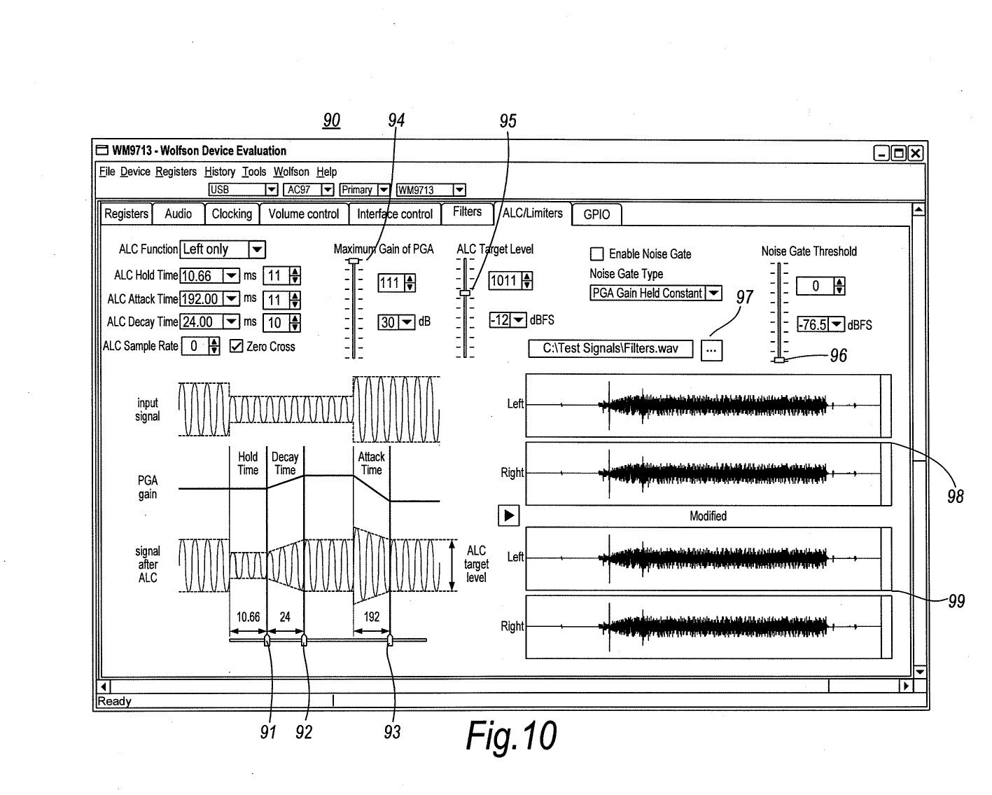

Another form of interactive setting diagram, conceptually similar to FIG. 10, is shown in FIG. 11. This helps the user to set up various kinds of dynamic range-modifying effects such as compression, limiting, ALC and noise gate (these effects are sometimes referred to collectively as ALC) which are available to be applied to an audio signal. It presents the current settings on the conceptual diagram of the ALC, with instant feedback on a test signal.

As before, these settings can be controlled intuitively, by direct interaction with the diagram. For example, a graphical display of an envelope in the lower left-hand portion of the Figure is provided with sliders 91, 92 and 93 for setting of a hold time, decay time and attack time respectively for use in the ALC. Additional slider controls 94, 95 and 96 allow other parameters such as the gain of a programmable gain amplifier, a target level at which ALC is to be applied, and a threshold for applying a noise gate, to be set intuitively as an alternative to entering numerical values in the traditional way. Similarly as in FIG. 9, a control 97 is provided for selecting a test signal. A waveform display 98 shows the waveform of the test signal before applying ALC, and a waveform display 95 shows the waveform after processing. In addition, it is possible to reproduce the test file audibly to the engineer. Thus, the effects of the settings are demonstrated.

Alternatively, the corresponding settings can be applied directly to the device and the effects can be heard directly through the device.

This has various benefits: the settings are easy to interpret and update, and it is clear how the settings relate to the timing on the device. Updates are made by interacting directly with the a representation of an envelope, providing a consistent metaphor and allowing a very natural interaction. Users can see and hear the effects before and after on a real-world test signal. The user can learn how the level control works and how the various components are inter-related by experimenting and getting instant feedback.

FIG. 11, as already referred to, provides a register map 100 showing the value of each register, an example of which is indicated at 101, or each register field such as 102, of the device. As the user changes settings on any interactive block diagram or setting diagram as referred to above, the concomitant effects on register values are made automatically by the software and the register map updated. The user can review the register map at any time to see the effects of changes made.

More particularly, the register map 100 is preferably an interactive register map of the kind proposed in UK patent application no. 0701733.8. This visually distinguishes actual from pending values, to help the user to know whether changes to settings have actually been submitted to the device or are still pending. Changes can instantly be associated with register fields, since they will be highlighted as pending changes in the register map. Furthermore, such an interactive register map makes it clear what the default setting is, and changed values are highlighted. This has benefits for debugging issues as it restricts the settings which need to be investigated. It also has benefits for developing software sequences as it highlights the registers which have been altered to achieve the current state.

The evaluation software as outlined above has the ability to save as a file a configuration, achieved by the user performing a sequence of operations with the interactive setting diagram(s), and reload the saved sequence of operations. When investigating scenarios and/or issues with devices, it is sometimes necessary to replay the same scenario repeatedly until it fails, or to select different operations based on certain conditions, or to have a common file with minor differences for multiple devices. Other requirements might include to wait until a certain condition is met, or to duplicate settings from one register/device and apply them to another. Many other similar scenarios can be imagined. At present all this intelligence has to be applied by the engineer selecting the operations manually by interacting with the software, or selecting different stored sequences manually based on the current configuration.

To assist the user, the file format can be enhanced to capture this intelligence. Additions can include:
variables, which can store values read from one register and be used to apply them to other registers/devices.
arithmetic such as addition, subtraction, multiplication, division, exponentiation, etc.
logical operations such as masking, combination (logical AND, OR, XOR, inversion, etc).
conditional evaluation of code: conditions can include equality, inequality, greater/less-than (inclusive and exclusive), etc, and combinations of these. The parser can support simple conditions (IF x THEN y) and/or multiple conditions (IF x THEN y ELSE z, CASE A do foo, CASE B do bar, CASE C do baz, etc).
looping constructs: a sequence of operations may be repeated a certain number of times, while a condition is true, until a condition is false, etc, possibly with operations for breaking out of the loop early.
subroutines: sequences of operations (possibly parameterised) which can be executed from other operations or in response to certain conditions.

As will be apparent to those skilled in the art, the above additions are most conveniently provided by providing a programming language for the operator, allowing him or her to manipulate replay of scenarios and operations, by specifying the desired logical operations, conditions and so forth when calling saved sequences of operations or individual operations. The above list is not exhaustive, and further extensions will occur to those skilled in the art, following the principle of providing programmatic control over the operations performed.

As a further enhancement, referring back to the evaluation scenario of FIG. 1, it is possible to use the evaluation software to assist mounting of the DUT 1 on the evaluation board 3. Traditionally, evaluation boards are configured by moving jumpers around on the board. This means there is no way of ensuring the appropriate board layout for a certain setup without providing the customer a document specifying which jumpers to attach where. It is also not possible to find out how the board is configured from the software (to diagnose a customer problem, for example). To overcome this problem, it would be possible for the board configuration to be controlled via programmable electronics which can be accessed (set up and queried) from the evaluation software. So for example, a jumper which allows the user to manually select between two or more modes or signals could be replaced by a programmable mux or relay which can be controlled in software from the computer (possibly after translation by appropriate interface circuitry and firmware). This configuration can be presented and controlled via options in a further interactive block diagram (showing the board) or in any other desired way.

As already mentioned, the various interactive setting diagrams provided by the present invention are displayed by software running on a computer. To reduce the effort required in developing software for a particular electronic device, the concept of a device descriptor is preferably used. The device descriptor works in conjunction with software for displaying one or more interactive setting diagrams, such that the computer can be used with any device under test, without requiring the whole software to be rewritten. The device descriptor comprises a data file containing information about the device under test. For example, the data file may comprise:
general information relating to the device (for example ID/name, revision level, reported ID, supported control interfaces and interface formats, number of bits per register),
information relating to the specific registers themselves (for example register: name; index/address; description; default value; register access type; other flags),
information relating to each data field (for example: start/end bits; name; description; default value; field access; other flags), and
data field format (for example describing whether a data field is represented by a toggle switch, slider, drop-down menu, etc)
information relating to blocks within the device (for example name, type/function, associated control data fields and values, relative power consumption); this information used to drive the display and configuration of that block in a diagram
information relating to the signals input into a block (for example their source; how to enable/disable them; how the signals are modified on input to a block, e.g. relative amplification or attenuation for an audio signal; signal type, e.g. audio, clock; phase information); this information used to generate routing diagrams, calculate optimal routes, calculate clock domains
generic optimal sequences for initialisation and shutdown which can be used to generate specific sequences which are artefact- and power-optimised

Having this information in the device descriptor means that adding support for a new device only requires the writing of a new device descriptor and adding this to the set of descriptors available to the software (without requiring any modifications to the software that displays the interactive setting diagram and responsive to user input manipulating the interactive setting diagram).

To summarise, embodiments of the present invention facilitate evaluation, testing and/or configuration of an electronic device by providing one or more interactive setting diagrams are in the form of a block diagram for showing inter-relationships of functional blocks of the device, and/or a diagram for showing signal processing functions of the device. In the case of an audio IC for example, respective block diagrams may be provided for audio routing, for clocking, for general purpose I/IO, and so on. Likewise, signal processing may be represented by diagrams for configuring filters and ALC. The diagrams are displayed on a display of a computer, having an input device which the user operates to change settings of the device. The user can interact directly with the interactive setting diagram by manipulating graphical controls incorporated into the diagram. Thus, for example, an audio path can be set by clicking on a signal line shown in the diagram, or filter settings modified by moving sliders displayed alongside a filter characteristic graph. Settings made in this way can be recorded for future re-use and/or reflected immediately in a register map of the device which may be connected to the computer via an evaluation board and interface.

Although the above embodiments have been described as a combination of interactive setting diagrams available as tabs in a common software program, this is not essential and an embodiment of the present invention may usefully provide any one or more of the described kinds of interactive setting diagram. In the case of a complex DUT, it will be preferable to display an interactive setting diagram focussing on only one aspect of the device operation, but for a simpler device it may be possible to cover all configuration aspects of the device by a single diagram. Alternatively, a single block diagram might be employed to cover all connection and routing issues with a single setting diagram for the more conceptual signal processing issues.

Although the above description has referred to a specific type of audio IC by way of illustration, the invention is of course not restricted either to this type of audio IC or to audio devices in general. It may be applied to any kind of user-configurable device whether digital or mixed-signal, so long as it is capable of being controlled digitally for at least some of its functions.

According to a further aspect of the invention, there is provided a computer program for performing a method as claimed in the embodiments above. The invention also relates to a computer-readable medium comprising such a computer program.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of configuring, through a computer, an electronic device external to and connected to the computer, the device comprising a plurality of functional components, each component having at least one associated control setting stored in registers within the electronic device, the method comprising the steps of:
(a) the computer displaying the components as blocks of an interactive block diagram of at least one configuration aspect of the device;
(b) the user selecting a component by interaction with the interactive block diagram;
(c) in response to the selection of a component, the computer allowing the user to set a said control setting associated with the component, and modifying the interactive block diagram to reflect said setting; and
(d) the computer configuring the electronic device by writing values to one or more of the registers of the electronic device in accordance with the settings made by the user.

2. The method according to claim 1 further comprising repeating steps (a) to (c) for any other parameter of said signal processing function requiring configuration by the user, prior to performing step (d).

3. The method according to claim 1 wherein each component has at least one possible connection path to other components of the device, a device routing being defined by combining the possible connection paths, each possible connection path being displayed as part of the interactive block diagram.

4. The method according to claim 3 further comprising a step of the user selecting a said connection path, and in response to selection of a connection path, the computer highlighting the path in the interactive block diagram.

5. The method according to claim 4 further comprising, in response to selection of a connection path, adding the path to said device routing if it is not already included, or removing the path from the device routing if it is already included.

6. The method according to claim 1 wherein a plurality of the interactive block diagrams are provided for different said configuration aspects of the device, the method including allowing the user to navigate from one interactive block diagram to another.

7. A method of configuring, through a computer, a signal processing function of an electronic device external to and connected to the computer, the device providing a plurality of signal processing operations each having at least one parameter requiring configuration by a user, such parameters being represented by values stored in registers within the electronic device and capable of depiction in graphical form, the method comprising the steps of:
(a) the computer displaying one or more interactive setting diagrams showing said at least one parameter requiring configuration by a user in the form of a graphical display;
(b) the user manipulating the graphical display to indicate a desired setting or change in setting of the parameter;
(c) in response to said manipulation, the computer updating a stored value of the parameter and modifying the graphical display to reflect the updated stored value;
(d) the computer configuring said signal processing function of the electronic device by writing values to the registers within the device.

8. The method according to claim 7 further comprising repeating steps (a) to (c) for any other parameter of said signal processing function requiring configuration by the user, prior to performing step (d).

9. The method according to claim 7 wherein the device is an audio processor and the signal processing functions include filtering of an audio signal, the interactive setting diagram including a filter response curve of the audio processor.

10. The method of claim 1, further comprising the steps of configuring, through a computer, a signal processing function of an electronic device external to and connected to the computer, the device providing a plurality of signal processing operations each having at least one parameter requiring configuration by a user, such parameters being represented by values stored in registers within the electronic device and capable of depiction in graphical form, and wherein the method further comprises the steps of:
(a) the computer displaying one or more interactive setting diagrams showing said at least one parameter requiring configuration by a user in the form of a graphical display;
(b) the user manipulating the graphical display to indicate a desired setting or change in setting of the parameter;
(c) in response to said manipulation, the computer updating a stored value of the parameter and modifying the graphical display to reflect the updated stored value;
(d) the computer configuring said signal processing function of the electronic device by writing values to the registers within the device, and
wherein in response to the user indicating a desired setting or change in setting of a parameter shown on the interactive setting diagram, the computer also modifies the display of the interactive block diagram to reflect the desired setting or change in setting, or vice-versa.

11. The method according to claim 1 further comprising the computer maintaining a register map storing values of registers used in operation of said device, and wherein in response to the user setting a said control setting associated with the component in the interactive block diagram, or indicating a desired setting of the parameter on the interactive setting diagram, the computer updates the register values to reflect this setting.

12. The method according to claim 7 further comprising the computer maintaining a register map storing values of registers used in operation of said device, and wherein in response to the user setting a said control setting associated with the component in the interactive block diagram, or indicating a desired setting of the parameter on the interactive setting diagram, the computer updates the register values to reflect this setting.

13. A system comprising an electronic device and a computer for configuring the electronic device, the device comprising a plurality of functional components, each component having at least one associated control setting, and registers for storing values corresponding to the control settings, the computer connected to the electronic device and comprising:
control means for generating an interactive block diagram of at least one configuration aspect of the device;
a display for displaying the components as blocks of the interactive block diagram; and
an input device arranged for manipulation by the user to select a component and determine a control setting thereof by interaction with the interactive block diagram; wherein
said control means are responsive to manipulation of the input device to set said control setting and modify the interactive block diagram to reflect said setting; and
said control means are operable, following the user's manipulation of the input device, to configure the electronic device by writing values to said registers in accordance with the control settings made by the user.

14. A system comprising an electronic device and a computer for configuring a signal processing function of the electronic device, the device providing a plurality of signal processing operations each having at least one parameter requiring configuration by a user and capable of depiction in graphical form, the device comprising registers for storing values corresponding to the parameters, the computer connected to the electronic device and comprising:
control means for generating one or more interactive setting diagrams showing said at least one parameter requiring configuration by a user;
a display for displaying the one or more interactive setting diagrams in the form of a graphical display; and
input means arranged for manipulation by the user to interact with the graphical display to indicate a desired setting or change in setting of the parameter;
said control means being responsive to said manipulation to update a stored value of the parameter and modify the graphical display to reflect the updated stored value; and
said control means being operable, following the user's manipulation of the input means, to configure said signal processing function of the electronic device by writing said values to said registers in accordance with the settings made by the user.

15. The system according to claim 12 wherein the computer is arranged for communication of signals with an evaluation board carrying the electronic device.

16. The system according to claim 13 wherein the computer is arranged for communication of signals with an evaluation board carrying the electronic device.

17. A computer-readable medium comprising a computer program for performing a method as claimed in claim 1.

18. A computer-readable medium comprising a computer program for performing a method as claimed in claim 7.
